(19) United States
(12) Patent Application Publication
(10) Pub. No.: US 2019/0313584 A1
(43) Pub. Date: Oct. 17, 2019

(54) LED Lighting/Gardening Device and Office Screen Comprising the Device

(71) Applicant: Emi Stop Corp., New Taipei City (TW)

(72) Inventor: Wei-Chen Chen, New Taipei City (TW)

(21) Appl. No.: 16/470,143

(22) PCT Filed: Sep. 4, 2017
(86) PCT No.: PCT/CN2017/100318

§ 371 Date: Jun. 14, 2019

(30) Foreign Application Priority Data
Jan. 26, 2017 (CN) 201710061658.7

(51) Int. Cl. A01G 7/04; H05B 33/08; H05B 37/02

(52) U.S. Cl. CPC A01G 7/045; H05B 37/0218; H05B 33/0842

(57) ABSTRACT

An office screen includes a screen frame and an LED lighting/gardening device. The frame includes a table board and multiple screen boards connected together and supporting the table board. The LED lighting/gardening device includes a container for growing a plant, means for installing the container on top of the screen boards, and an LED lighting source arranged above the container and containing multiple LEDs affixed to a support. The LEDs are located at a predetermined distance from a top of the plant, and located at a height from the table board, such that the LED lighting source provides the plant with an illumination level not greater than a photosynthesis light saturation point of the plant, and provides an illumination for the table board, wherein the predetermined distance between the LEDs and the top of the plant is less one quarter of the height between the LEDs and the table board.

### FIELD OF THE INVENTION

The present invention relates to an LED lighting/gardening device, and an office screen comprising the device.

### BACKGROUND OF THE INVENTION

Plants can perform photosynthesis and respiration. Photosynthesis uses light energy to combine water with carbon dioxide to produce glucose, and release oxygen. To ensure this chemical reaction, adequate light is required. In respiration, plants use oxygen to convert glucose to energy needed by their cells, while to release carbon dioxide.

Generally, an increase in illuminance (unit of measurement: Lux) enhances photosynthesis on plants. Light compensation point is known as the light intensity or illuminance, at which the rate of photosynthesis matches the rate of respiration, and the uptake of carbon dioxide through photosynthesis matches the respiratory release of carbon dioxide. Photosynthesis light saturation point is known as the light intensity or illuminance, at which increasing the light intensity no longer causes an increase in photosynthesis. Plants can be classified into sun type and shade types according to their characteristics in collecting sunlight. For sun-type plants, the light compensation point is about 5000 Lux, and the light saturation point is about 25,000 Lux. For shade-type plants, the light compensation point is about 2000 Lux, and the light saturation point is about 7500 Lux.

Currently, indoor plants are mostly for ornamental purposes. Arrangement of indoor light sources for a building generally focuses on the demands of daily life (about 100-300 Lux) and reading and painting activities (about 500-600 Lux). Such light intensity is far from the light compensation point for indoor plants. On the other hand, when the light intensity is increased to reach the light compensation point, persons living or working in the building may feel glare. Under the circumstances of failing to provide adequate illumination, due to the indoor plants unable to conduct full photosynthesis, the plants will compete with people to consume oxygen. Thus, it is not appropriate to plant too many plants indoors.

In recent years, due to environmental changes and the evolution of social atmosphere, the use of pesticides for crops has begun to be rejected. In addition, the use of LEDs is advantageous in various aspects, such as low power consumption, long service life, small size, shock resistance and easy operation, and thus LEDs have become a promising lighting source, which makes indoor planting possible and has been applied to some crops that are planted indoors to avoid the threats of weather change and environmental pollution. However, due to oxygen competition and different light intensity requirements, this type of plant factories that grows a large number of plants indoors has to be separated from the human living space, and this makes those plant factories being nothing to do with greening of a working and living environment.

Therefore, the present invention is specifically directed to an office arrangement. Generally, workers usually need to work eight or nine hours a day (including the middle meal break time), and usually do not leave their office areas. For an office furniture design, each person is given a specific small area surrounded by screen boards, wherein each area accommodates a table and needs sufficient lighting, which means that office furniture needs to be illuminated in each working day. Additionally, the greening and air composition of the workplace should also be paid attention to. Due to the concentration of workers, if there is no special treatment, the air in the workplace sometimes contains too much carbon dioxide, making workers easy to feel tired and reduce work efficiency. When the light intensity is insufficient and each table is furnished with plants, more oxygen can be consumed, making the environment worse.

The illumination level or intensity on an object is inversely proportional to the square of the distance between the object and the light source. To solve the above problem, when locating a light source for a table furnished with a plant, the distance between the light source and the plant's top can be set about one quarter to one tenth of the distance between the light source and the table. Furthermore, glare can be avoided by blocking light rays from directly entering a person's eyes. As such, the light source does not only provide adequate illumination required for photosynthesis of the plant, but also provide soft illumination suitable for reading and working. Besides, this arrangement can provide more oxygen in the working time, thus improving the indoor air quality. Particularly, since most persons spend eight to ten hours in working or reading a day, which is enough for plants to conduct photosynthesis to produce energy, when workers leave the workplace, the shared light sources can be switched off. However, the plants can still continue consuming oxygen according to the natural cycle of the plants. The illumination level required for the plants is fully matched with the working time set for workers, and additional power consumption is not required thereafter.

The present invention intends to provide an office screen, wherein an LED lighting/gardening device is employed, which can provide high illumination for indoor plants and low illumination suitable for working and reading. As a result, the planting area, the growth of plants, the efficiency of energy use, as well as the air quality of the workplace can be increased.

### SUMMARY OF THE INVENTION

One object of the present invention is to provide an office screen, which leverages a screen frame in cooperation with an LED lighting/gardening device to increase the planting area.

Another object of the present invention is to provide an LED lighting/gardening device, which employs an LED lighting source that can be controlled easily to increase the efficiency of photosynthesis and to ensure the illumination level required for growing plants. Thus, during working hours, adequate oxygen can be provided for people, and the indoor air quality can be improved.

A further object of the present invention is to provide an LED lighting/gardening device, which employs an LED lighting source that can be controlled easily to provide more illumination for plants to ensure proper photosynthesis as well as to avoid glare of the lighting source, so that a proper working environment can be ensured, and the lighting source can be used more efficiently.

The LED lighting/gardening device comprises at least one container for growing at least one plant, means for installing the container on top of screen boards of an office screen; and at least one LED lighting source arranged above the container. The LED lighting source includes a plurality of LEDs affixed to a support. The LEDs are located at a predetermined distance from a top of the plant, and located at a height from a table board of the office screen, such that the LED lighting source provides the plant with an illumination level not greater than a photosynthesis light saturation point of the plant, as well as provides an illumination for the table board, wherein the predetermined distance between the LEDs and the top of the plant is less than one quarter of the height between the LEDs and the table board.

The office screen of the present invention, which employs the structure design of a screen frame and the LED lighting/gardening device, is featured in that the LED lighting source can be controlled easily to increase the planting area, the growth of plants, the efficiency of energy use, and the air quality of the workplace, and to improve the indoor environment.

### BRIEF DESCRIPTION OF THE DRAWINGS

The foregoing and other features and advantages of illustrated embodiments of the present invention will be more readily apparent from the following detailed description, which proceeds with reference to the accompanying drawings.

FIG. 1 shows a schematic 3-dimensional view of a first embodiment of an LED lighting/gardening device according of the present invention.

FIG. 2 shows a schematic 3-dimensional view of a second embodiment of an LED lighting/gardening device of the present invention, which is L-shaped and includes a square column.

FIG. 3 shows a schematic 3-dimensional view of a third embodiment of an LED lighting/gardening device of the present invention, which is T-shaped and includes a square column.

FIG. 4 shows a schematic 3-dimensional view of a fourth embodiment of an LED lighting/gardening device of the present invention, which is X-shaped and includes a square column.

FIG. 5 shows a schematic 3-dimensional view of a fifth embodiment of an LED lighting/gardening device of the present invention, which is Y-shaped and includes a triangular column.

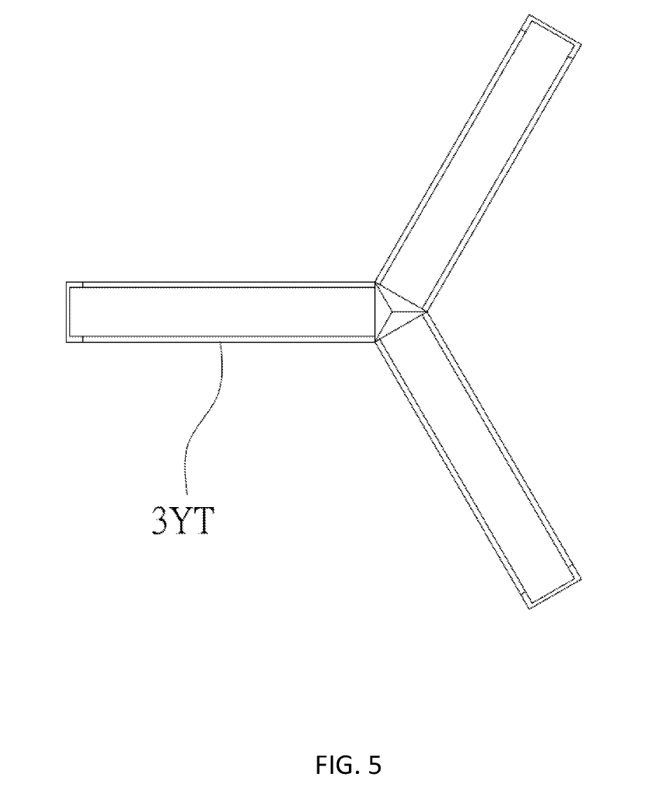

FIG. 6 shows a schematic 3-dimensional view of a sixth embodiment of an LED lighting/gardening device of the present invention, which is Y-shaped and includes a cylindrical column.

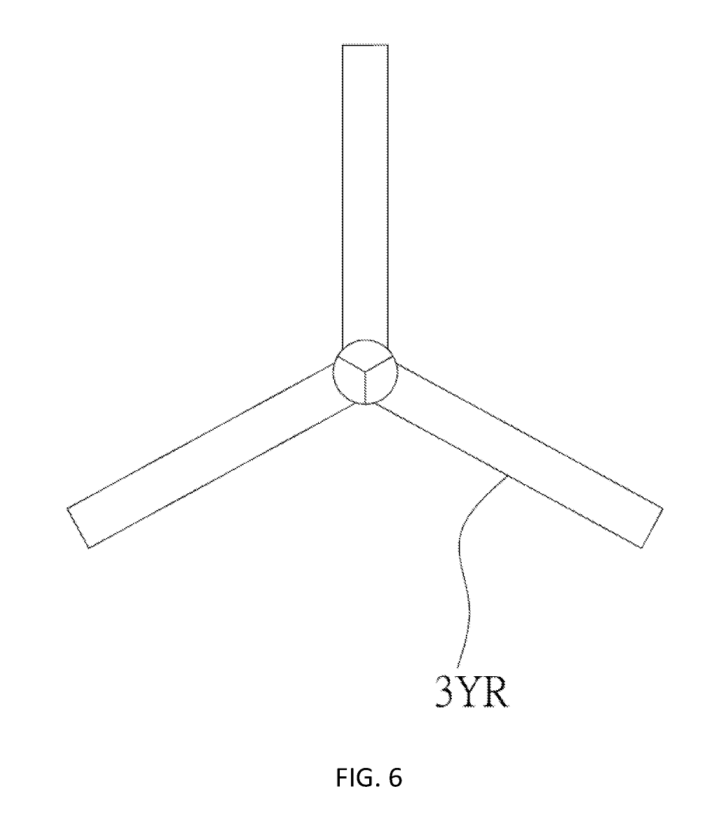

FIG. 7 show a schematically 3-dimensional view of a first embodiment of an office screen of the present invention, wherein two pieces of the L-shaped device shown in FIG. 2 are employed in the office screen.

FIG. 8 shows a schematic view illustrating the growth of a plant according to the first embodiment of the office screen.

FIG. 9 show a schematic 3-dimensional view of part of a second embodiment of an office screen of the present invention, wherein the LED lighting source can be moved vertically by a raising/lowering unit, some light rays emitting from the light source can be blocked by a movable plate.

FIG. 10 shows a schematic view illustrating the growth of a plant according to the second embodiment of the office screen.

### DETAILED DESCRIPTION OF THE ILLUSTRATED EMBODIMENTS

The foregoing and other technical contents, features and advantages of the present invention will be illustrated in detail by way of exemplary embodiments in the following paragraphs with reference to the accompanying drawings. In the exemplary embodiments, same elements will be indicated by similar numerals or labels. The drawings show the structural features of elements, which are not always depicted in proportion.

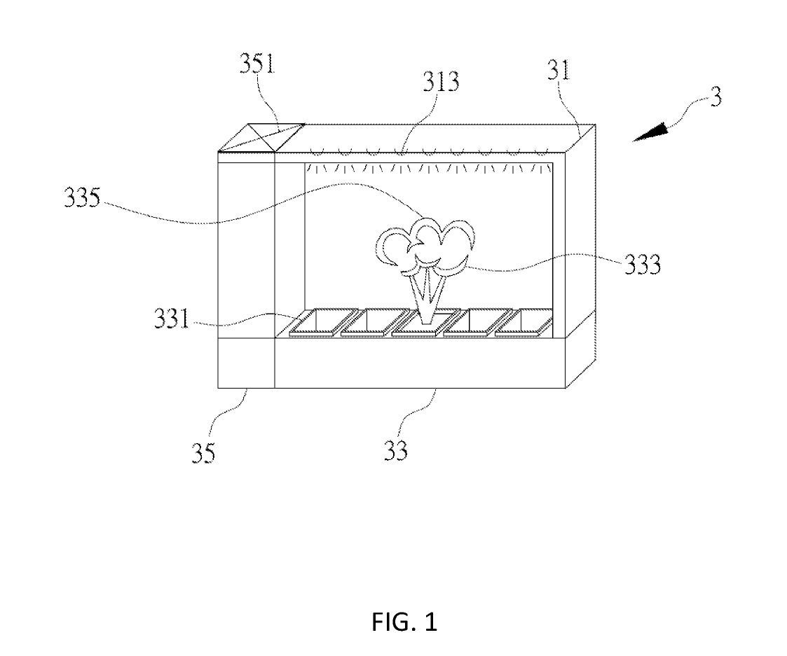

FIG. 1 shows an LED lighting/gardening device, which generally includes a container 33 for growing plants, and an LED lighting source 31 arranged above the container 33. Both of the container 33 and the LED lighting source 31 are joined to a connection means 35, on which a control unit 351 is provided. Through the connection means 35, the LED lighting/gardening device becomes an integral structure and can be installed on top of screen boards of a piece of office screen furniture. To strengthen the entire structure, an inverted L-shaped support joined to the container 33 is used in the LED lighting source 31. Multiple LEDs 313 are affixed to a lower surface of the L-shaped support, so that the LED lighting/gardening device forms into an integral structure. As shown, the container 33 defines a plurality of accommodation spaces 331, each of which can accommodate a plant 333, the highest part of which is referred to herein as the plant top 335.

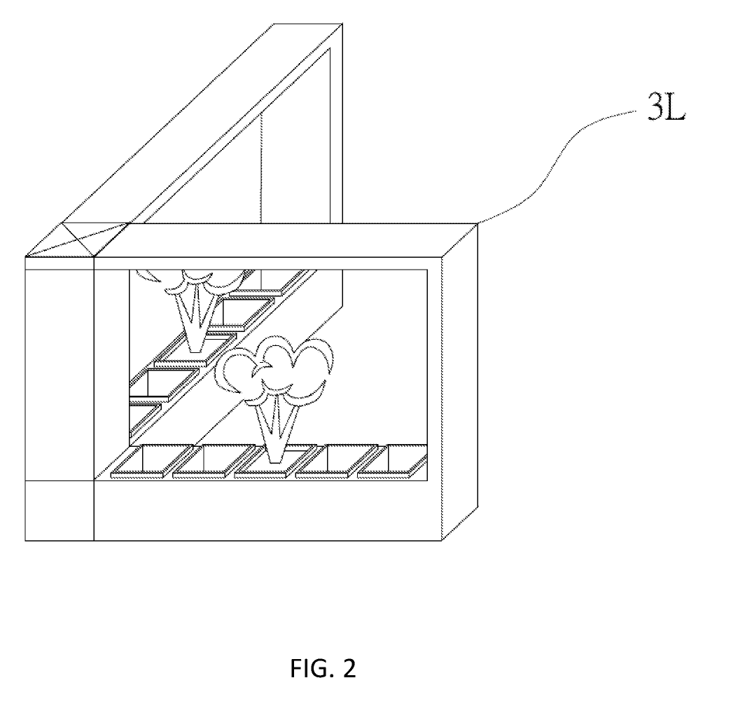

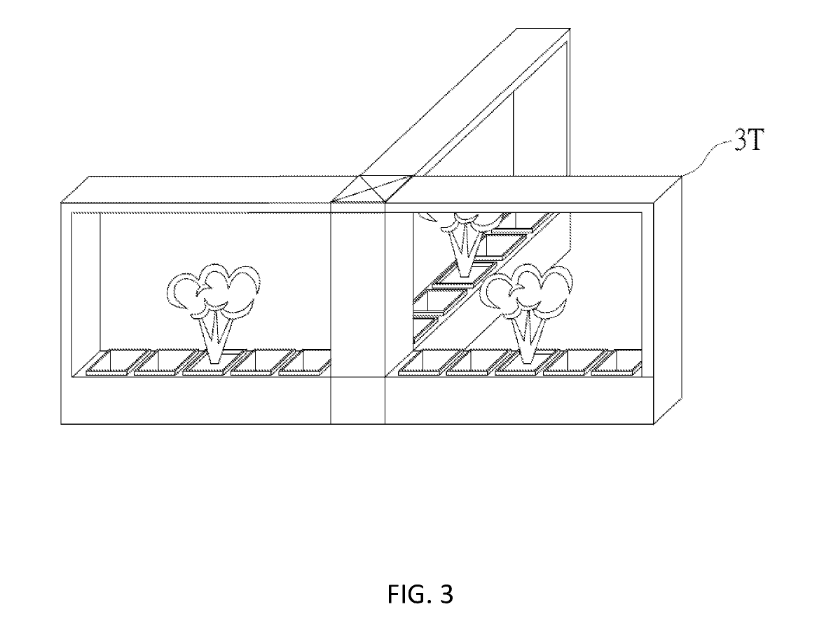

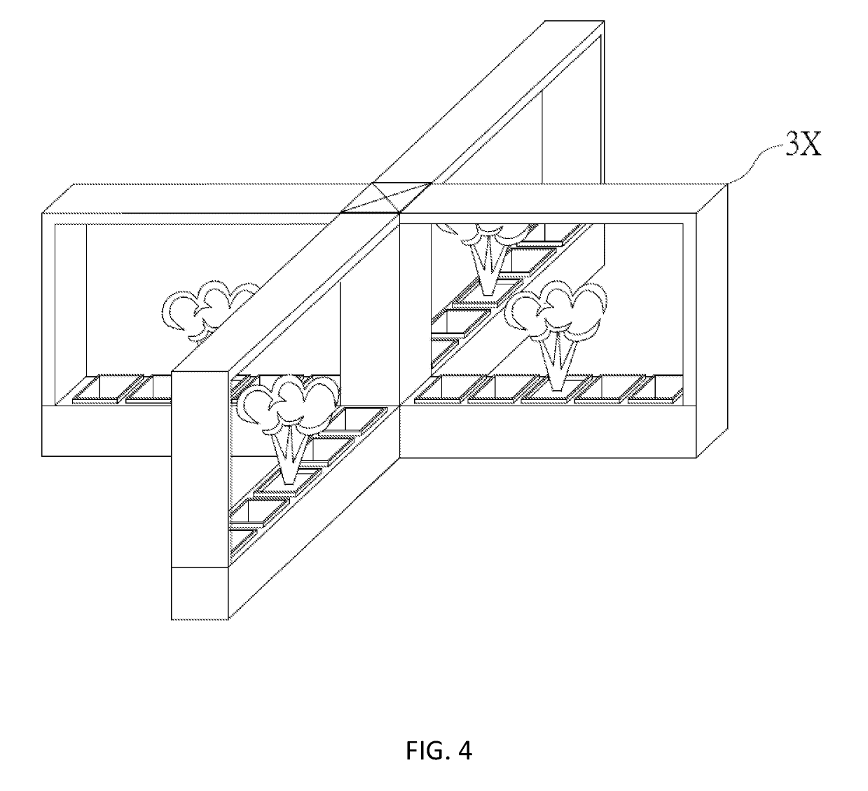

In FIG. 1, the connection means 35 is shown as a square column, which can be installed on the frame of an office screen, wherein both of the LED lighting device 31 and the container 33 are joined to one side of the square column, thus forming a plate-shaped structure. Nevertheless, the other sides of the square column can also be used to join other LED lighting sources and containers, so that structures of other shapes, such as L-shaped structures (3L), T-shaped structures (3T), and X-shaped structures (3X), can be obtained (see FIGS. 2 through 4). In addition to the square column, a cylindrical or triangular column can be used as a connection means for joining LED lighting sources and containers to form a Y-shaped structure (3YT or 3YR)

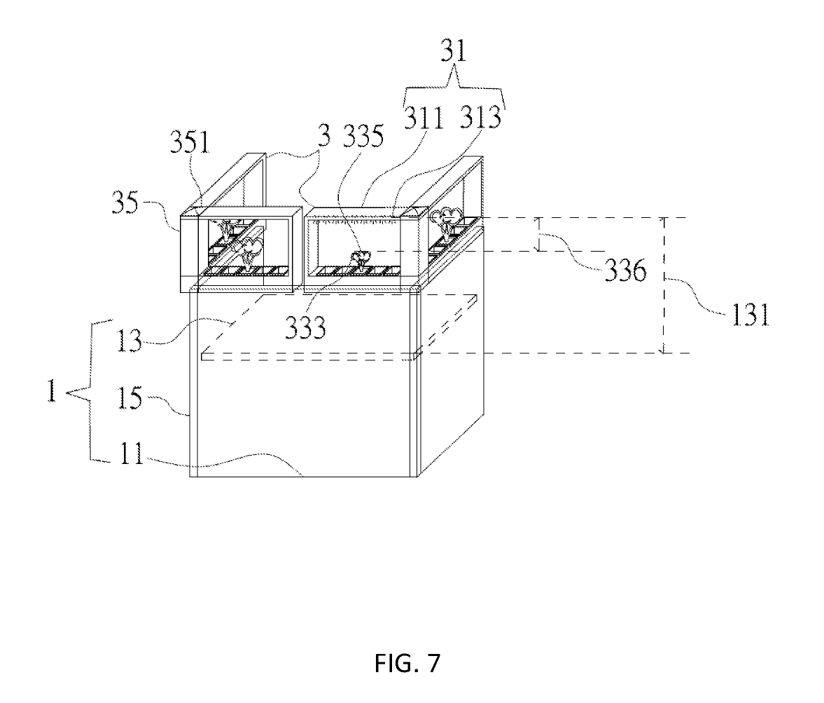

FIG. 7 shows a first embodiment of an office screen of the present invention, which generally includes a screen frame 1 and two LED lighting/gardening devices 3. The screen frame 1 includes screen boards 11 and a table board 13. Through a joining means 15, the screen boards 11 and the table board 13 are joined together, such that the screen frame 1 appears to be a U-shaped frame, on which the two L-shaped structures (as shown in FIGS. 2) are located. Each L-shaped structure is installed on top of the screen boards 11 through a connection means 35 and provided thereon a control unit 351, which allows a user to set an illumination level or intensity required for the plant 333 on the LED lighting source 351, so that the plant 333 can obtain adequate light, and the table board 13 can be illuminated properly. In this embodiment, the control unit 351 may contain a memory for storing a value set by the user.

The LED lighting source 31 may include a support 311 and a plurality of LEDs 313 affixed to the undersurface of the support 311. At the initial stage of planting, the distance 336 between the LEDs 313 and the plant top 335 is configured to be slightly less than one quarter of the distance 131 between the LEDs 313 and the table board 13 (i.e. the height of the LEDs), so that the illumination level at the plant top 335 is about 16 times of the illumination level at the table board 13. In addition, the illumination level at the plant top 335 is slightly greater than the light compensation point of the plant 333. Under this circumstance, the release of oxygen through photosynthesis is greater than the uptake of oxygen by respiration, so that the air quality can be improved. Also, desktop illumination is appropriate, and glare from the lighting source can be avoided.

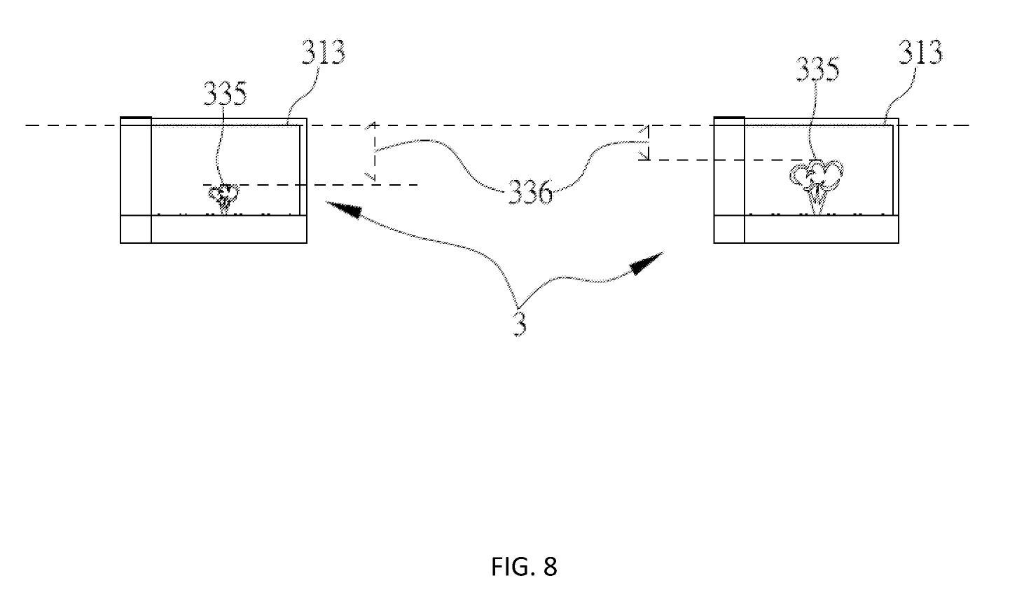

FIG. 8 shows a comparison between the initial stage and the mature stage of the plant 333, wherein the left side shows that the plant is at the initial stage, whereas the right side shows that the plant is at the mature stage. The distance 336 between the LEDs 313 and the plant top 335 is decreasing as time elapses. However, the distance between the LEDs 313 and table board 13 (i.e. the height of the LEDs, see FIG. 7) remains the same. At the initial stage, the ratio of the distance 336 to the LED height is about 1/4. When the ratio reaches between 1/7 and 1/10, the illumination level at the plant is about 50 to 100 times of the illumination level at the table board. As such, the illumination level provided on the plant gradually approaches the photosynthesis saturation point of the plant, at which an increase in the illumination level does not cause an increase in photosynthesis. The plant can be harvested according to the photosynthesis saturation point thereof.

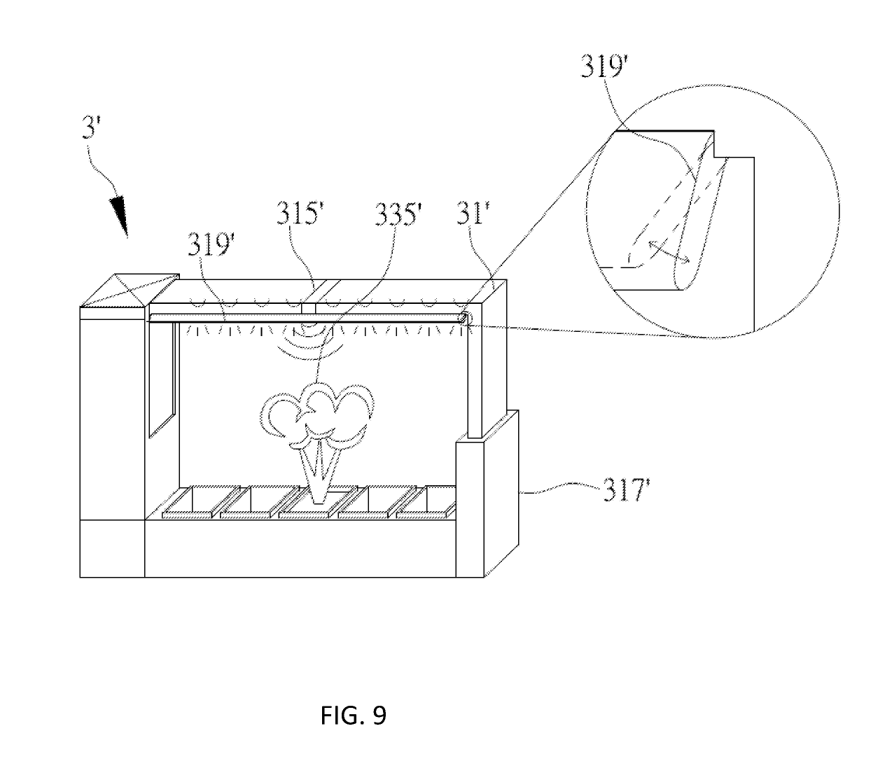

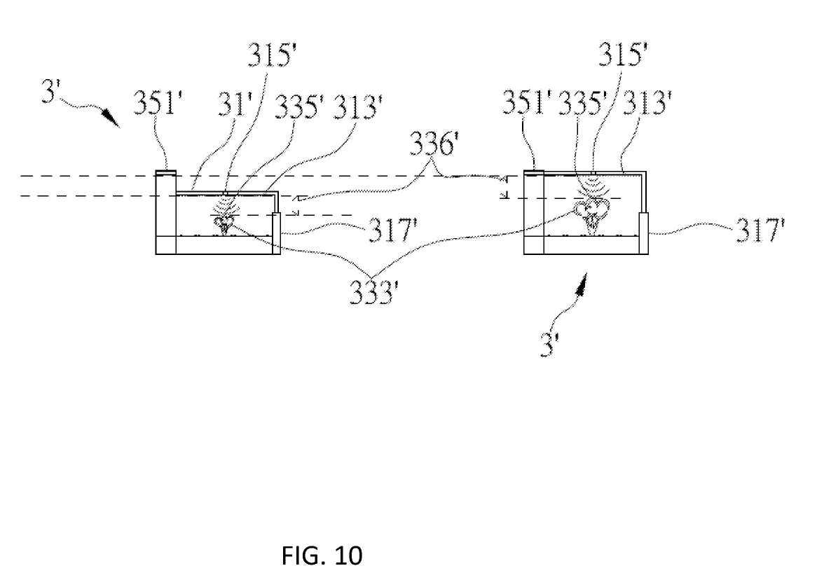

FIGS. 9 and 10 show a second embodiment of the office screen of the present invention, wherein the screen frame is the same as the first embodiment. The LED lighting/gardening device 3′ is basically the same as that of the first embodiment, except that this embodiment further includes a distance measurement unit 315′, a raising/lowering unit 317′, and a movable shielding plate 319′, wherein the distance measurement unit 315′ can measure the distance 336′ between the LEDs 313′ and the plant top 335′; the raising/lowering unit 317′ can control and adjust the height of the LED lighting source 31′; the movable shielding plate 319′ can be tilted to prevent light rays emitting from the LEDs 313′ from directly aiming at the user's eyes, and thus glare from the lighting source, which causes the user discomfort, can be avoided.

In this embodiment, in addition to the LED lighting source 31′ being set for its lighting time, the distance measurement unit 315′ can be used to measure the distance 336′ between the LEDs 313′ and the plant top 335′. The intensity of the LED lighting source 31′ can be adjusted according to the position of the table board so that proper illumination at the table board can be obtained. Furthermore, the raising/lowering unit 317′ can be used to move the LED lighting source 31′ to a height, so that the distance 336′ between LEDs 313′ and the plant top 335′ is about one quarter to one tenths of the height of the LEDs 313′ with respect to the table board, and the illumination level at the plant top can reach approximately the photosynthesis saturation point. As such, the plant 333′ can make food in a most effective way, and thus grows quickly.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the scope of the invention.

What is claimed is:

1. A lighting/gardening device for office screens, comprising:
at least one container for growing at least one plant;
means for installing the container on top of screen boards of an office screen; and
at least one LED lighting source arranged above the container, the LED lighting source including a plurality of LEDs affixed to a support, the LEDs being located at a predetermined distance from a top of the plant, and being located at a height from a table board of the office screen, such that the LED lighting source provides the plant with an illumination level not greater than a photosynthesis light saturation point of the plant, as well as provides an illumination for the table board, wherein the predetermined distance between the LEDs and the top of the plant is less than one quarter of the height between the LEDs and the table board.

2. The lighting/gardening device of claim 1, further comprising a control unit capable of controlling the illumination level for the plant.

3. The lighting/gardening device of claim 2, further comprising a raising/lowering unit capable of adjusting the height of the LED lighting source.

4. The lighting/gardening device of claim 3, further comprising a distance measurement unit capable of measuring the distance between the LEDs and the top of the plant.

5. The lighting/gardening device of claim 1, further comprising a movable shielding plate to reduce glare from the LED lighting source.

6. An office screen, comprising:
a screen frame including at least one table board and a plurality of screen boards connected together and supporting the table board; and
at least one LED lighting/gardening device, which includes at least one container for growing at least one plant, means for installing the container on top of the screen boards, and at least one LED lighting source arranged above the container and containing a plurality of LEDs affixed to a support, the LEDs being located at a predetermined distance from a top of the plant, and being located at a height from the table board, such that the LED lighting source provides the plant with an illumination level not greater than a photosynthesis light saturation point of the plant, as well as provides an illumination for the table board, wherein the predetermined distance between the LEDs and the top of the plant is less one quarter of the height between the LEDs and the table board.

7. The office screen of claim 6, wherein the lighting/gardening device further includes a raising/lowering unit capable of adjusting the height of the LED lighting source.

8. The office screen of claim 6, wherein the lighting/gardening device further includes a control unit capable of controlling the illumination level for the plant.

9. The office screen of claim 7, wherein the lighting/gardening device further includes a distance measurement unit capable of measuring the distance between the LEDs and the top of the plant.

10. The office screen of claim 6, wherein the lighting/gardening device further includes a movable shielding plate to reduce glare from the LED lighting source.
